(19) United States
(12) Patent Application Publication
(10) Pub. No.: US 2025/0239753 A1
(43) Pub. Date: Jul. 24, 2025

(54) POWER COMBINER AND POWER DISTRIBUTOR

(71) Applicant: Panasonic Intellectual Property Management Co., Ltd., Osaka (JP)

(72) Inventors: MIKIO FUKUI, Nara (JP); SHINJI TAKANO, Gifu (JP); TAKASHI UNO, Shiga (JP)

(21) Appl. No.: 18/835,399

(22) PCT Filed: Feb. 9, 2023
(86) PCT No.: PCT/JP2023/004315

§ 371 Date: Feb. 7, 2025

(30) Foreign Application Priority Data
Feb. 25, 2022 (JP) 2022-028415

(51) Int. Cl. H01P 5/12; H01P 3/12; H01Q 13/08

(52) U.S. Cl. CPC H01P 5/12; H01P 3/12; H01Q 13/08

(57) ABSTRACT

Power combiner (11) includes: cavity (2) that has internal space (20) sealed electromagnetically; a plurality of input ports (4, 5) that are disposed in cavity (2); a plurality of input antennas (41, 51), each of which is disposed at a corresponding input port among the plurality of input ports (4, 5), that are disposed inside internal space (20); and output port (3) that is disposed in cavity (2). Power distributor (12) includes: cavity (2) that has internal space (20) sealed electromagnetically; input port (3) that is disposed in cavity (2); input antenna (31) that is connected to input port (3) and disposed inside internal space (20); and a plurality of output ports (4, 5) that are disposed in cavity (2).

### TECHNICAL FIELD

The present disclosure relates to a power combiner and a power distributor.

### BACKGROUND ART

Patent Literature 1 discloses a waveguide circuit (power combiner, power distributor) that performs power combination or power distribution in a high frequency band. The waveguide circuit described in Patent Literature 1 includes a first waveguide, a second waveguide, and a third waveguide each having a cross-sectional shape that allows a TE mode to propagate.

A tube axis of the second waveguide is in parallel with a tube axis of the first waveguide. A side wall on a short side of the second waveguide is opposite to a side wall on a short side of the first waveguide. The third waveguide has a coupling portion that couples a hollow channel of the third waveguide to each of hollow channels of the first waveguide and the second waveguide.

### CITATION LIST

### Patent Literature

PTL: Japanese patent No. 6279190

### SUMMARY OF THE INVENTION

The waveguide circuit described in Patent Literature 1 has a complexed structure in which a plurality of waveguides are combined. In the waveguide circuit, if input/output ends of the first waveguide and input/output ends of the second waveguide are used as four input ports, the microwave inputted to one of the four input ports may be propagated to the remaining three input ports, other than an output port.

To prevent this, it is necessary to disposedielectric members or the like to secure an isolation between the input ports. However, this may cause an increase in power loss.

The present disclosure aims to provide a power combiner and a power distributor that can reduce power loss with a simple structure.

A power combiner in accordance with one aspect of the present disclosure includes a cavity, a plurality of input ports, a plurality of input antennas, and an output port.

The cavity has an internal space sealed electromagnetically. The plurality of input ports are disposed in the cavity. Each of the plurality of input antennas is disposed in a corresponding input port among the plurality of input ports, and is disposed inside the internal space. The output port is disposed in the cavity.

A power distributor in accordance with another aspect of the present disclosure includes a cavity, an input port, an input antenna, and a plurality of output ports.

The cavity has an internal space sealed electromagnetically. The input port is disposed in the cavity. The input antenna is disposed in the input port and disposed inside the internal space. The plurality of output ports are disposed in the cavity.

The power combiner and the power distributor in accordance with the above-mentioned aspects of the present disclosure can reduce power loss with a simple structure.

### BRIEF DESCRIPTION OF DRAWINGS

FIG. 1 is a perspective view showing an internal structure of a power distributor/combiner in accordance with a first exemplary embodiment of the present disclosure.

FIG. 2 is a perspective view showing an appearance of the power distributor/combiner in accordance with the first exemplary embodiment, when viewed from the above.

FIG. 3 is a perspective view showing an appearance of the power distributor/combiner in accordance with the first exemplary embodiment, when viewed from the below.

FIG. 4 is a perspective cross-sectional view of the power distributor/combiner in accordance with the first exemplary embodiment.

FIG. 5 is a plan view of the power distributor/combiner in accordance with the first exemplary embodiment.

FIG. 6 is a cross-sectional view taken along line 6-6 in FIG. 5.

FIG. 7 is a view for describing an electric power flow and an electric field strength in a cross-sectional view of a power combiner in accordance with the first exemplary embodiment.

FIG. 8 is a view for describing the electric power flow and the electric field strength in a plan view of the power combiner in accordance with the first exemplary embodiment.

FIG. 9 is a graph showing an example of a relationship between frequency and a combination rate in the power combiner in accordance with the first exemplary embodiment.

FIG. 10 is a view for describing an electric power flow and an electric field strength in a cross-sectional view of a power distributor in accordance with the first exemplary embodiment.

FIG. 11 is a view for describing the electric power flow and the electric field strength in a plan view of the power distributor in accordance with the first exemplary embodiment.

FIG. 12 is a graph showing an example of a relationship between frequency and a distribution rate in the power combiner in accordance with the first exemplary embodiment.

FIG. 13 is a plan view showing a first example of a power distributor/combiner in accordance with a second exemplary embodiment of the present disclosure.

FIG. 14 is a cross-sectional view taken along line 14-14 in FIG. 13.

FIG. 15 is a perspective view showing a second example of the power distributor/combiner in accordance with the second exemplary embodiment.

FIG. 16 is a cross-sectional view taken along line 16-16 in FIG. 15.

FIG. 17 is a graph showing an example of a relationship between frequency and a combination rate in the power distributor/combiner in accordance with the second exemplary embodiment.

FIG. 18 is a plan view showing a power distributor/combiner in accordance with a third exemplary embodiment of the present disclosure.

FIG. 19 is a cross-sectional view taken along line 19-19 in FIG. 18.

FIG. 20 is a graph showing an example of a relationship between frequency and a combination rate in a power combiner in accordance with the third exemplary embodiment.

FIG. 21 is a perspective view showing a power combiner in accordance with a fourth exemplary embodiment of the present disclosure, when viewed from the above.

FIG. 22 is a perspective view showing the power combiner in accordance with the fourth exemplary embodiment of the present disclosure, when viewed from the below.

FIG. 23 is a plan view of the power combiner in accordance with the fourth exemplary embodiment.

FIG. 24 is a cross-sectional view taken along line 24-24 in FIG. 23.

FIG. 25 shows a graph showing an example of a relationship between frequency and a combination rate in the power combiner in accordance with the fourth exemplary embodiment.

### DESCRIPTION OF EMBODIMENTS

Hereinafter, exemplary embodiments will be described in detail with reference to the drawings as necessary. However, detailed explanation about already well-known matters and overlapped description about the substantially same configurations are occasionally omitted.

### First Exemplary Embodiment

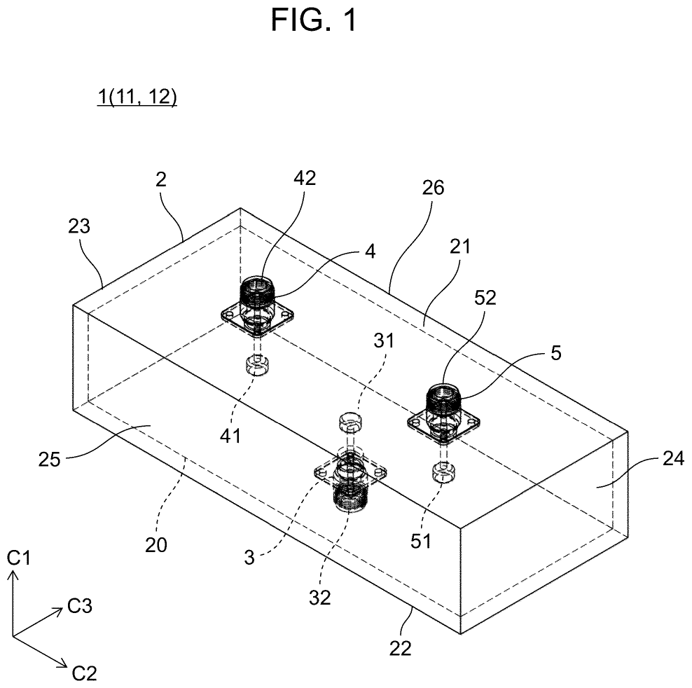

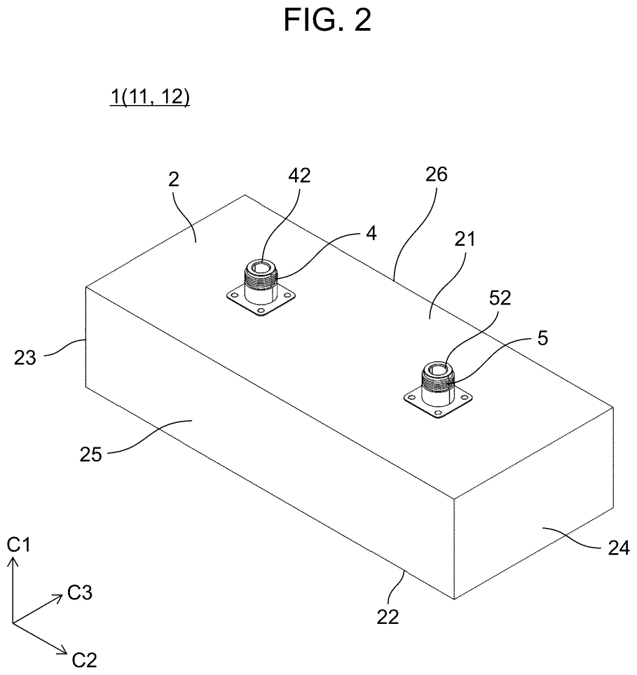

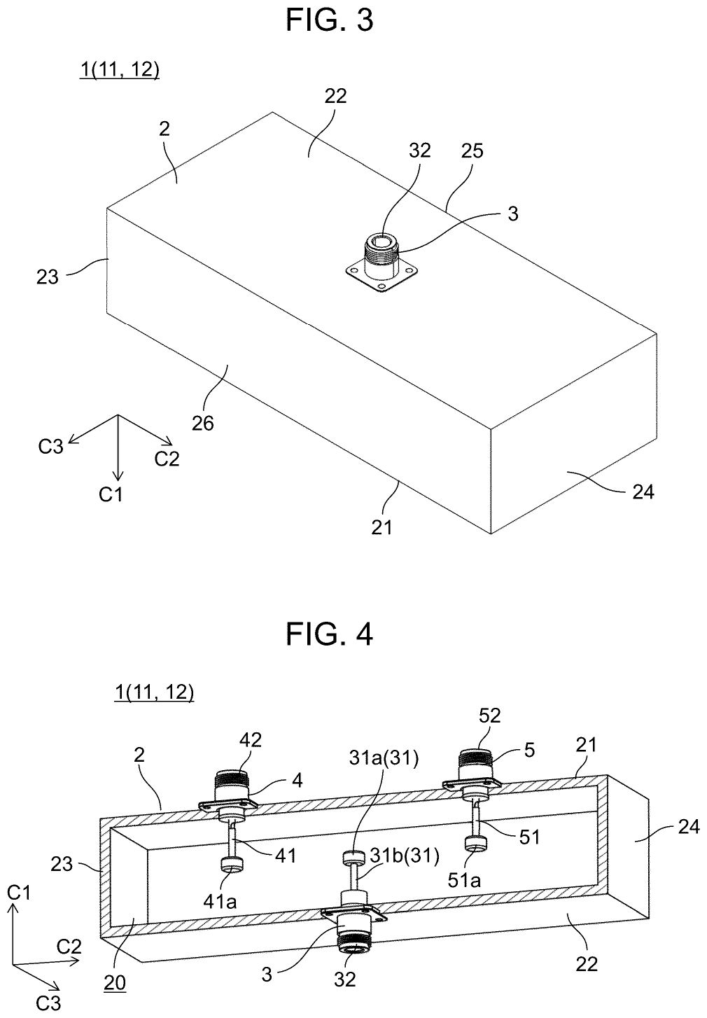

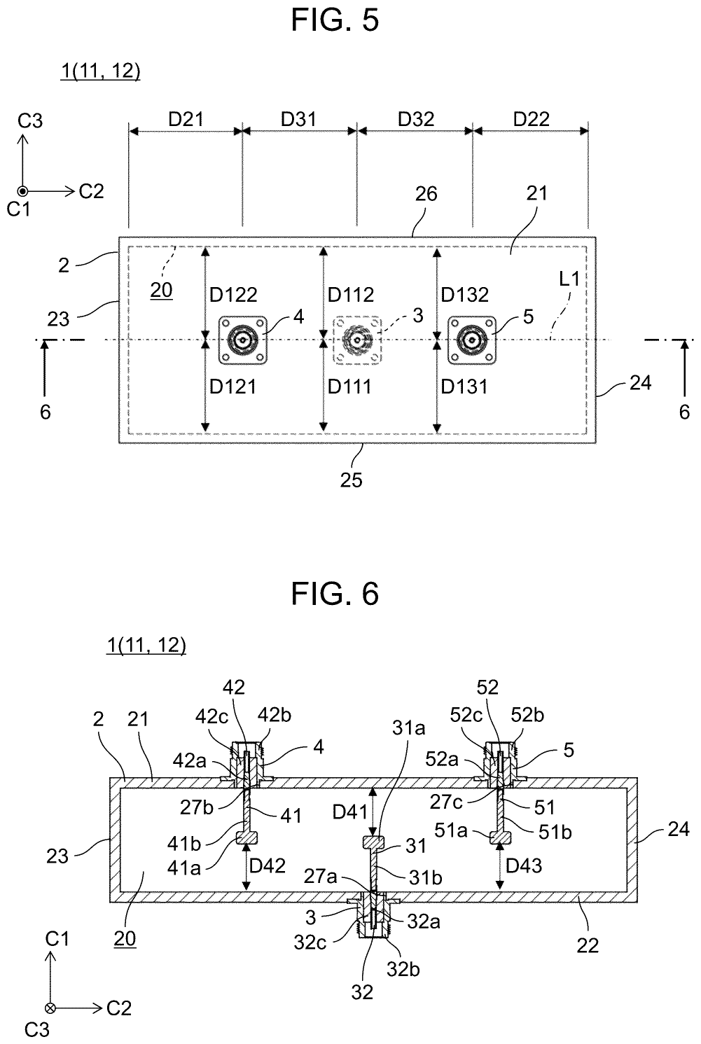

FIGS. 1 through 6 each show power distributor/combiner 1 in accordance with a first exemplary embodiment of the present disclosure. In more detail, FIG. 1 is a perspective view showing an internal structure of power distributor/combiner 1. FIG. 2 is a perspective view showing an appearance of power distributor/combiner 1, when viewed from the above. FIG. 3 is a perspective view showing an appearance of power distributor/combiner 1, when viewed from the below. FIG. 4 is a perspective cross-sectional view of power distributor/combiner 1. FIG. 5 is a plan view of power distributor/combiner 1. FIG. 6 is a cross-sectional view taken along line 6-6 in FIG. 5.

Power distributor/combiner 1 is used as, especially, a power combiner or a power distributor for high frequency signals. When power distributor/combiner 1 is used as a power combiner, power distributor/combiner 1 is written as power combiner 11. When power distributor/combiner 1 is used as a power distributor, power distributor/combiner 1 is written as power distributor 12.

As shown in FIGS. 1 through 6, power distributor/combiner 1 includes cavity 2, first port 3, second port 4, and third port 5.

Cavity 2 has internal space 20 sealed electromagnetically. Cavity 2 is made of metal. The material of cavity 2 is aluminum, for example. Cavity 2 has a rectangular parallelepiped shape.

Cavity 2 has first wall 21 and second wall 22 that intersect with first axis C1 perpendicularly. First wall 21 and second wall 22 each have a rectangular plate of the same shape. Cavity 2 has third wall 23 and fourth wall 24 that intersect with second axis C2 perpendicularly. Third wall 23 and fourth wall 24 each have a rectangular plate of the same shape. Cavity 2 has fifth wall 25 and sixth wall 26 that intersect with third axis C3 perpendicularly. Fifth wall 25 and sixth wall 26 each have a rectangular plate of the same shape.

Note that, as shown in FIGS. 1 and 2, the first axis is an axis extending vertically. As shown in FIGS. 3 and 4, second axis C2 is an axis extending in a left-right direction of cavity 2 and intersects with first axis C1 perpendicularly. As shown in FIGS. 1 through 4, third axis C3 is an axis extending in a depth direction of cavity 2 and intersects with both of first axis C1 and second axis C2 perpendicularly.

In the present exemplary embodiment, cavity 2 has the largest dimension along second axis C2, the second largest dimension along third axis C3, and the smallest dimension along first axis C1.

As shown in FIGS. 1 through 6, cavity 2 has mounting hole 27a, mounting hole 27b, and mounting hole 27c into which first port 3, second port 4, and third port 5 are attached, respectively. Mounting hole 27a, mounting hole 27b, and mounting hole 27c are disposed so as to be positionally aligned with first port 3, second port 4, and third port 5, respectively.

Internal space 20 of cavity 2, which is surrounded by first wall 21 through sixth wall 26, is sealed electromagnetically. Cavity 2 has mounting holes 27a, 27b, and 27c. Although not being sealed spatially, internal space 20 of cavity 2 can be considered to be sealed electromagnetically.

As mentioned above, power distributor/combiner 1 is used as power combiner 11 or power distributor 12.

When power distributor/combiner 1 is used as power combiner 11, first port 3 is used as an output port, and second port 4 and third port 5 are used as a plurality of input ports. Electric powers, each of which is a high frequency signal with the same frequency, are inputted to each of the plurality of input ports. Power combiner 11 combines the electric powers, which are inputted to second port 4 and third port 5, and outputs it from first port 3.

When power distributor/combiner 1 is used as power distributor 12, first port 3 is used as an input port, and second port 4 and third port 5 are used as a plurality of output ports. An electric power, which is a high frequency signal with a predetermined frequency, is inputted to the input port. Power distributor 12 distributes the electric power, which is inputted to first port 3, and outputs it from second port 4 and third port 5.

As shown in FIGS. 4 and 6, antenna 31 and connector 32 are disposed in first port 3.

Antenna 31 is disposed inside internal space 20 of cavity 2. Antenna 31 is used as an output antenna in power combiner 11, and as an input antenna in power distributor 12.

Antenna 31 has a round rod-shape. The material of antenna 31 is copper, for example. Antenna 31 has tip part 31a and body part 31b. A diameter of tip part 31a is larger than a diameter of body part 31b. Antenna 31 is disposed to cause a discharge not to occur between tip part 31a and cavity 2.

Connector 32 is disposed outside internal space 20 of cavity 2. Connector 32 is used for connecting power distributor/combiner 1 to an external device. In the present exemplary embodiment, connector 32 is a coaxial connector capable of connecting with a coaxial cable. Connector 32 includes inner conductor 32a of a rod form, outer conductor 32b of a cylindrical shape that surrounds inner conductor 32a, and insulator 32c that is disposed between inner conductor 32a and outer conductor 32b.

First port 3 is attached to cavity 2 via mounting hole 27a. In the present exemplary embodiment, mounting hole 27a is formed in second wall 22. Connector 32 is fixed to an external surface of second wall 22 such that inner conductor 32a is exposed to internal space 20 via mounting hole 27a. Antenna 31 is connected to inner conductor 32a of connector 32 in body part 31b.

As shown in FIGS. 1, 4, and 6, antenna 41 and connector 42 are disposed in second port 4.

Antenna 41 is disposed inside internal space 20 of cavity 2. Antenna 41 is used as an input antenna in power combiner 11, and as an output antenna in power distributor 12.

Antenna 41 has a round rod-shape. The material of antenna 41 is copper, for example. Antenna 41 has tip part 41a and body part 41b. A diameter of tip part 41a is larger than a diameter of body part 41b. Antenna 41 is disposed to cause a discharge not to occur between tip part 41a and cavity 2.

Connector 42 is disposed outside internal space 20 of cavity 2. Connector 42 is used for connecting power distributor/combiner 1 to an external device. In the present exemplary embodiment, connector 42 is a coaxial connector capable of connecting with a coaxial cable. Connector 42 includes inner conductor 42a of a rod form, outer conductor 42b of a cylindrical shape that surrounds inner conductor 42a, and insulator 42c that is disposed between inner conductor 42a and outer conductor 42b.

Second port 4 is attached to cavity 2 via mounting hole 27b. In the present exemplary embodiment, mounting hole 27b is formed in first wall 21. Connector 42 is fixed to an external surface of first wall 21 such that inner conductor 42a is exposed to internal space 20 via mounting hole 27b. Antenna 41 is connected to inner conductor 42a of connector 42 in body part 41b.

As shown in FIGS. 1, 4, and 6, antenna 51 and connector 52 are disposed in third port 5.

Antenna 51 is disposed inside internal space 20 of cavity 2. Antenna 51 is used as an input antenna in power combiner 11, and as an output antenna in power distributor 12.

Antenna 51 has a round rod-shape. The material of antenna 51 is copper, for example. Antenna 51 has tip part 51a and body part 51b. A diameter of tip part 51a is larger than a diameter of body part 51b. Antenna 51 is disposed to cause a discharge not to occur between tip part 51a and cavity 2.

Connector 52 is disposed outside internal space 20 of cavity 2. Connector 52 is used for connecting power distributor/combiner 1 to an external device. In the present exemplary embodiment, connector 52 is a coaxial connector capable of connecting with a coaxial cable. Connector 52 includes inner conductor 52a of a rod form, outer conductor 52b of a cylindrical shape that surrounds inner conductor 52a, and insulator 52c that is disposed between inner conductor 52a and outer conductor 52b.

Third port 5 is attached to cavity 2 via mounting hole 27c. In the present exemplary embodiment, mounting hole 27c is formed in first wall 21. Connector 52 is fixed to an external surface of first wall 21 such that inner conductor 52a is exposed to internal space 20 via mounting hole 27c. Antenna 51 is connected to inner conductor 52a of connector 52 in body part 51b.

As mentioned above, antenna 31, antenna 41, and antenna 51 are disposed in first port 3, second port 4, and third port 5, respectively, and are disposed inside internal space 20 of cavity 2.

In other words, in power combiner 11, each of the plurality of input antennas (antennas 41 and 51) is disposed in a corresponding input port among the plurality of input ports (second port 4 and third port 5). In power distributor 12, each of the plurality of output antennas (antennas 41 and 51) is disposed in a corresponding output port among the plurality of output ports (second port 4 and third port 5).

In the present exemplary embodiment, as shown in FIG. 4, antenna 31 of first port 3, antenna 41 of second port 4, and antenna 51 of third port 5 have the same shape as one another. In more detail, tip part 31a of antenna 31, tip part 41a of antenna 41, and tip part 51a of antenna 51 have the same diameter and length. Body part 31b of antenna 31, body part 41b of antenna 41, and body part 51b of antenna 51 also have the same diameter and length.

First port 3 is disposed in cavity 2 as an output port of power combiner 11. Input radio waves, which correspond to the electric powers inputted to the plurality of input ports (second port 4 and third port 5), are emitted to internal space 20 from each input antenna (antenna 41, 51) in the plurality of input ports. These input radio waves are combined inside internal space 20 to form a combined wave. First port 3 outputs this combined wave to the outside of internal space 20.

Especially, when an output port (first port 3) is not provided, the output antenna (antenna 31) is preferably disposed at an antinode position of a standing wave that is caused by the input radio waves emitted from the plurality of input antennas (antennas 41 and 51).

The standing wave is a wave obtained such that two waves, which are the same in wavelength, cycle, and amplitude, but opposite to each other in traveling direction, are overlapped with each other. In the standing wave, there are two kinds of points, i.e., one does not oscillate at all, and the other has the maximum amplitude. The former is a node of the standing wave, and the latter is an antinode of the standing wave.

If a wavelength of the two waves, which are overlapped with each other, is defined as λ, a node and an antinode of the standing wave each will appear for every λ/2. Since the standing wave has the maximum amplitude at the antinode, if antenna 31 is disposed at an antinode position of the standing wave, an utilization efficiency of electric power can be improved.

In power distributor 12, an input radio wave, which corresponds to the electric power inputted to first port 3, is emitted to internal space 20 from antenna 31. The radio wave is distributed into two radio waves inside internal space 20. Second port 4 and third port 5, each of which functions as an output port of power distributor 12, output the two distributed radio waves one by one to the outside of internal space 20.

Especially, when the plurality of output ports (second port 4 and third port 5) are not provided, the plurality of output antennas (antennas 41 and 51) each are preferably disposed at an antinode position of a standing wave that is caused by the input radio wave emitted from the input antenna (antenna 31).

Next, an arrangement of first port 3, second port 4, and third port 5 in cavity 2 will be described in more detail.

As shown in FIGS. 2 through 4, second port 4 and third port 5 are disposed in first wall 21 of cavity 2, and first port 3 is disposed in second wall 22 of cavity 2. Accordingly, in cavity 2, first port 3 is disposed in the wall opposite to second port 4 and third port 5. In other words, the input port and the output port each are disposed in walls of cavity 2 opposite to each other.

As shown in FIG. 5, first port 3, second port 4, and third port 5 are aligned along second axis C2 of cavity 2 (in a left-right direction of FIG. 5), when viewed along first axis C1 of cavity 2.

Straight line L1 passing through first port 3, second port 4, and third port 5 corresponds to a center line in a direction of third axis C3 (in an up-down direction of FIG. 5) of cavity 2, when viewed along first axis C1 of cavity 2. When viewed along first axis C1, cavity 2 is line-symmetric with respect to straight line L1 passing through first port 3, second port 4, and third port 5.

As shown in FIG. 5, distance D111 between first port 3 and fifth wall 25 is set to cause a discharge not to occur between fifth wall 25 and tip part 31a (see FIG. 4) of antenna 31 in first port 3.

Similarly, distance D121 between second port 4 and fifth wall 25 is set to cause a discharge not to occur between fifth wall 25 and tip part 41a (see FIG. 4) of antenna 41 in second port 4. Distance D131 between third port 5 and fifth wall 25 is set to cause a discharge not to occur between fifth wall 25 and tip part 51a (see FIG. 4) of antenna 51 in third port 5.

Distance D112 between first port 3 and sixth wall 26 is set to cause a discharge not to occur between sixth wall 26 and tip part 31a (see FIG. 4) of antenna 31 in first port 3.

Similarly, distance D122 between second port 4 and sixth wall 26 is set to cause a discharge not to occur between sixth wall 26 and tip part 41a (see FIG. 4) of antenna 41 in second port 4. Distance D132 between third port 5 and sixth wall 26 is set to cause a discharge not to occur between sixth wall 26 and tip part 51a (see FIG. 4) of antenna 51 in third port 5. The distances D111, D121, D131, D112, D122, and D132 all are equal to each other.

As shown in FIG. 5, among first port 3, second port 4, and third port 5, second port 4 is closest to third wall 23 and third port 5 is closest to fourth wall 24.

Distance D21 between second port 4 and third wall 23 is set to cause a discharge not to occur between third wall 23 and tip part 41a of antenna 41 in second port 4. Distance D22 between third port 5 and fourth wall 24 is set to cause a discharge not to occur between fourth wall 24 and tip part 51a of antenna 51 in third port 5. Distance D21 is equal to distance D22.

As shown in FIG. 5, when viewed along first axis C1, first port 3, second port 4, and third port 5 are aligned along second axis C2 (in a left-right direction of FIG. 5) of cavity 2, and first port 3 is disposed in the center between second port 4 and third port 5.

In other words, distance D31 between first port 3 and second port 4 is equal to distance D32 between first port 3 and third port 5. Thus, when viewed along first axis C1, second port 4 and third port 5 are disposed symmetrically with respect to first port 3.

As shown in FIG. 6, distance D41 between first wall 21 and tip part 31a of antenna 31 in first port 3 is set to cause a discharge not to occur between first wall 21 and tip part 31a. Distance D42 between second wall 22 and tip part 41a of antenna 41 in second port 4 is set to cause a discharge not to occur between second wall 22 and tip part 41a. Distance D43 between second wall 22 and tip part 51a of antenna 51 in third port 5 is set to cause a discharge not to occur between second wall 22 and tip part 51a.

As shown in FIG. 6, distances D41 and D42 are set such that tip part 31a of antenna 31 is positionally overlapped with tip part 41a of antenna 41 in a direction of first axis C1 of cavity 2. Distances D41 and D43 are set such that tip part 31a of antenna 31 is positionally overlapped with tip part 51a of antenna 51 in a direction of first axis C1 of cavity 2. In the present exemplary embodiment, distances D41, D42, and D43 all are equal to each other.

In other words, in power combiner 11, the plurality of input antennas (antennas 41 and 51) are disposed to cause a discharge not to occur between cavity 2 and each tip part (tip part 41a, 51a) of the plurality of input antennas. The output antenna (antenna 31) is disposed to cause a discharge not to occur between cavity 2 and the tip part (tip part 31a) of the output antenna.

In power distributor 12, the plurality of output antennas (antennas 41 and 51) are disposed to cause a discharge not to occur between cavity 2 and each tip part (tip part 41a, 51a) of the plurality of output antennas. The input antenna (antenna 31) is disposed to cause a discharge not to occur between cavity 2 and the tip part (tip part 31a) of the input antenna.

Next, an operation of power distributor/combiner 1 will be described.

When power distributor/combiner 1 is used as power combiner 11, first port 3 is used as an output port, and second port 4 and third port 5 are used as the plurality of input ports. Electric powers, each of which is a high frequency signal, are inputted to connector 42 of second port 4 and connector 52 of third port 5.

An input radio wave, which corresponds to the electric power inputted to second port 4, is emitted to internal space 20 of cavity 2 from antenna 41. Further, an input radio wave, which corresponds to the electric power inputted to third port 5, is emitted to internal space 20 of cavity 2 from antenna 51.

Thus, inside internal space 20 of cavity 2, the input radio wave emitted from antenna 41 and the input radio wave emitted from antenna 51 are combined to cause a combined wave. First port 3 receives the combined wave via antenna 31, and outputs a high frequency signal, which corresponds to the combined wave, from connector 32.

Therefore, in power combiner 11, even if a dielectric member is not disposed between second port 4 and third port 5, the isolation between second port 4 and third port 5 can be secured. Since a dielectric member is not disposed, a power loss caused by the dielectric member can be avoided.

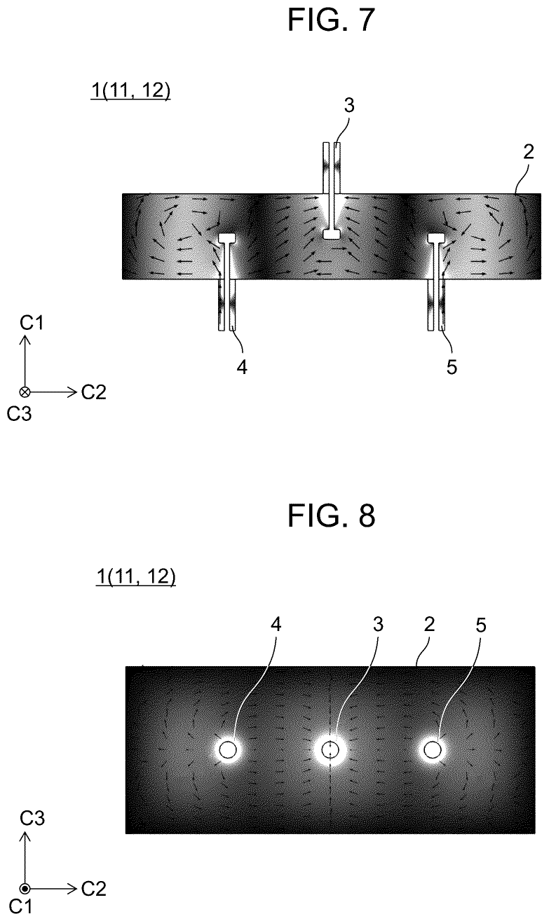

FIG. 7 is a view for describing an electric power flow and an electric field strength in a cross-sectional view of power combiner 11. FIG. 8 is a view for describing the electric power flow and the electric field strength in a plan view of power combiner 11. In FIGS. 7 and 8, an arrow is a Poynting vector (Poynting vector) that indicates an electric power flow. Light and shade indicate an electric field strength. This shows that the electric field strength becomes high as an area becomes bright, and becomes low as the area becomes dark.

FIGS. 7 and 8 show that the electric powers, which are inputted to second port 4 and third port 5, are combined to be outputted from first port 3.

First port 3 is disposed in cavity 2 as an output port of power combiner 11. Input radio waves, which correspond to the electric powers inputted to the plurality of input ports (second port 4 and third port 5), are emitted to internal space 20 from each input antenna (antenna 41, 51) in the plurality of input ports. These input radio waves are combined inside internal space 20 to form a combined wave. First port 3 outputs this combined wave to the outside of internal space 20.

When an output port (first port 3) is not provided, an output antenna (antenna 31) is preferably disposed at an antinode position of a standing wave that is caused by the input radio waves emitted from the plurality of input antennas (antennas 41 and 51).

To evaluate power loss in power combiner 11, the inventors have evaluated a combination rate of power combiner 11 using a network analyzer. To evaluate the combination rate, the inventors have inputted the same high frequency signal to second port 4 and third port 5 and, thereby, evaluated an electric power of the high frequency signal obtained from first port 3.

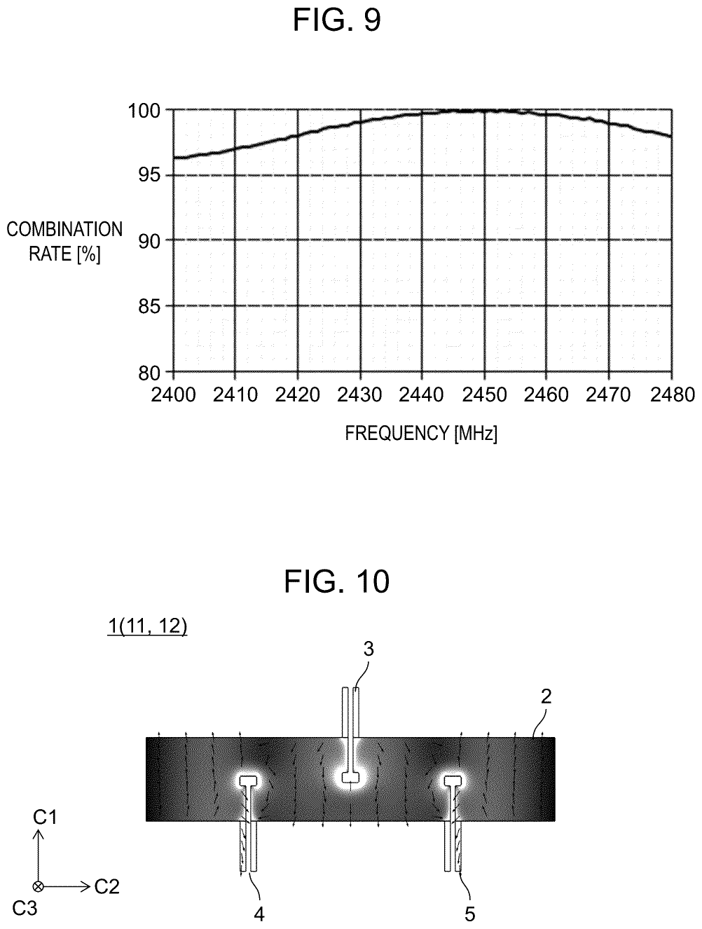

FIG. 9 is a graph showing an example of a relationship between frequency and a combination rate in power combiner 11. In FIG. 9, a horizontal axis indicates frequency of the high frequency signals inputted to the plurality of input ports (second port 4 and third port 5), and a vertical axis indicates a combination rate. The combination rate is a ratio of the electric power outputted from the output port (first port 3) to the electric power inputted to the plurality of input ports (second port 4 and third port 5).

As is clear from FIG. 9, a combination rate of more than 95% is obtained in a band ranging from 2400 MHz to 2480 MHz. Accordingly, power combiner 11 of the present exemplary embodiment can reduce power loss with a simple structure.

When power distributor/combiner 1 is used as power distributor 12, first port 3 is used as an input port, and second port 4 and third port are used as a plurality of output ports. An electric power, which is a high frequency signal, is inputted to connector 32 of first port 3.

An input radio wave, which corresponds to the electric power inputted to first port 3, is emitted to internal space 20 of cavity 2 from antenna 31. Antenna 41 of second port 4 and antenna 51 of third port 5 are disposed in internal space 20. For this reason, the input radio wave emitted from antenna 31 is distributed to antenna 41 and antenna 51.

Thus, power distributor 12 distributes the input radio wave, and outputs the distributed radio waves from connector 42 of second port 4 and connector 52 of third port 5.

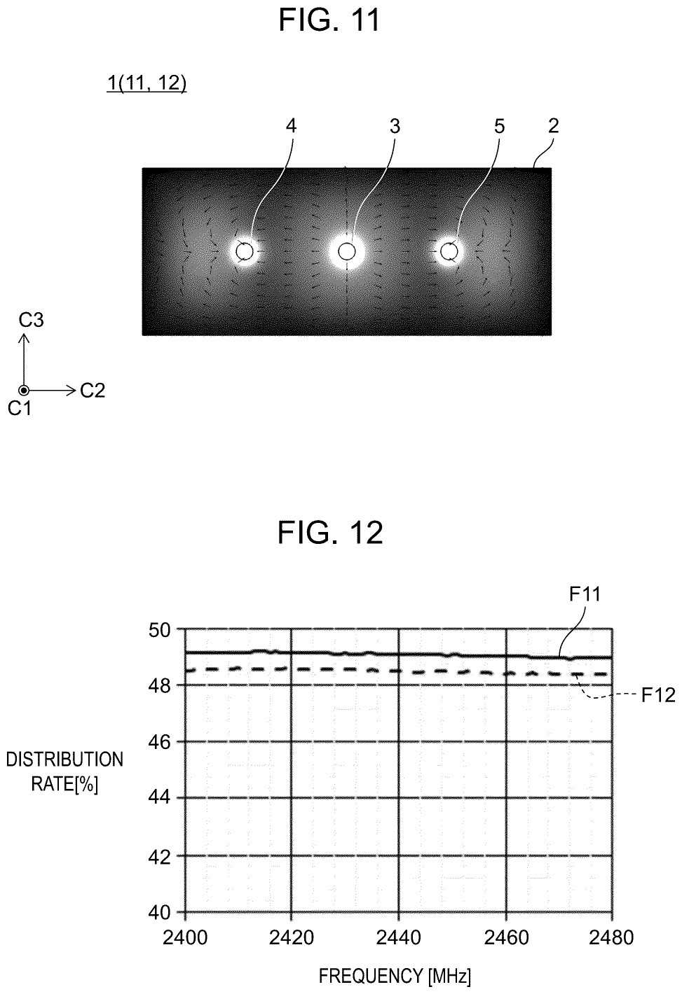

FIG. 10 is a view for describing an electric power flow and an electric field strength in a cross-sectional view of power distributor 12. FIG. 11 is a view for describing the electric power flow and the electric field strength in a plan view of power distributor 12. In FIGS. 10 and 11, an arrow is a Poynting vector (Poynting vector) that indicates an electric power flow. Light and shade indicate an electric field strength. This shows that the electric field strength becomes high as an area becomes bright, and becomes low as the area becomes dark.

FIGS. 10 and 11 show that the electric power inputted to first port 3 is distributed and outputted from second port 4 and third port 5.

Second port 4 and third port 5 are disposed in cavity 2 as a plurality of output ports of power distributor 12. Second port 4 and third port 5 distribute the input radio wave, which is received by an input port (first port 3) and emitted to internal space 20 from an input antenna (antenna 31) of the input port, and output the distributed radio waves to the outside of internal space 20.

When a plurality of output ports (second port 4 and third port 5) are not provided, a plurality of output antennas (antennas 41 and 51) each are preferably disposed at an antinode position of a standing wave that is caused by the input radio wave emitted from the input antenna (antenna 31).

To evaluate power loss in power distributor 12, the inventors have evaluated a distribution rate of power distributor 12 using a network analyzer. To evaluate the distribution rate, the inventors have inputted a high frequency signal to first port 3 and, thereby, evaluated an electric power of the high frequency signal obtained from second port 4 and third port 5.

FIG. 12 is a graph showing an example of a relationship between frequency and a distribution rate in power distributor 12. In FIG. 12, a horizontal axis indicates frequency of the high frequency signal inputted to an input port (first port 3), and a vertical axis indicates a distribution rate.

The distribution rate is a ratio of the electric power outputted from the output port (second port 4 or third port 5) to the electric power inputted to the input port (first port 3). In FIG. 12, F11 indicates a distribution rate of second port 4, and F12 indicates a distribution rate of third port 5. As is clear from FIG. 12, a distribution rate of more than 48% is obtained in a band ranging from 2400 MHz to 2480 MHz, for both of second port 4 and third port 5.

Note that, FIG. 12 shows that a distribution rate of second port 4 is higher than that of third port 5. It is considered that this occurs due to a dimension error at the time of manufacturing. Accordingly, power distributor 12 of the present exemplary embodiment can reduce power loss with a simple structure.

### Second Exemplary Embodiment

### First Example

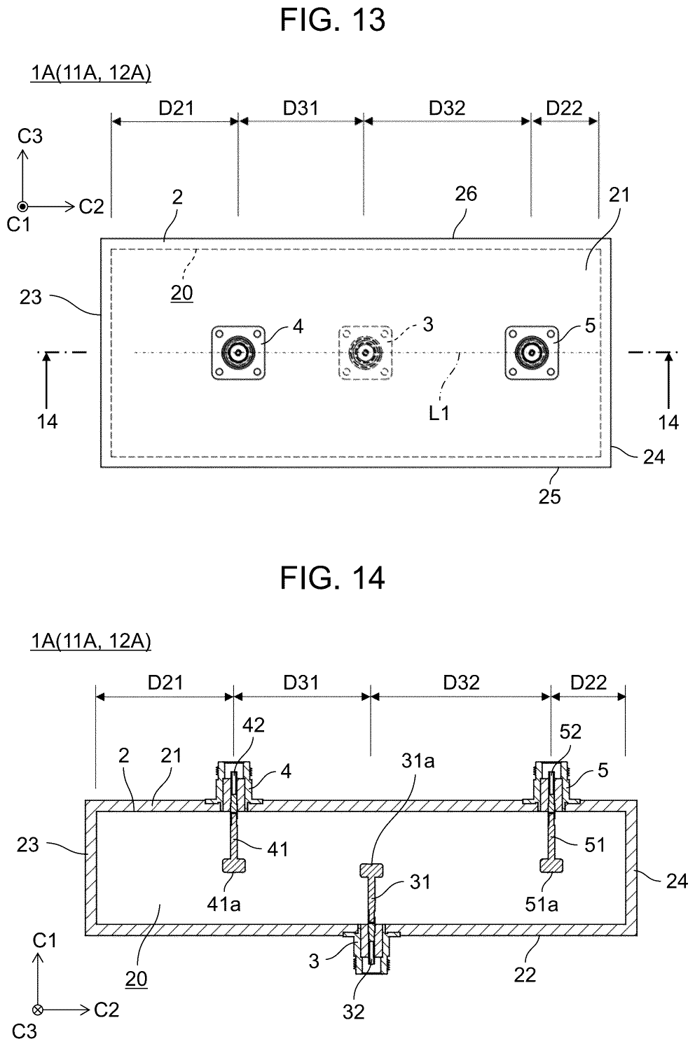

FIGS. 13 and 14 show power distributor/combiner 1A in accordance with a first example of a second exemplary embodiment in the present disclosure. FIG. 13 is a plan view of power distributor/combiner 1A. FIG. 14 is a cross-sectional view taken along line 14-14 in FIG. 13.

Power distributor/combiner 1A is used as power combiner 11A or power distributor 12A. Power distributor/combiner 1A includes cavity 2, first port 3, second port 4, and third port 5. Power distributor/combiner 1A is different from power distributor/combiner 1 in accordance with the first exemplary embodiment 1 in a manner of disposing first port 3, second port 4, and third port 5 in cavity 2.

As shown in FIGS. 13 and 14, in power distributor/combiner 1A, second port 4 and third port 5 are disposed in first wall 21 of cavity 2, and first port 3 is disposed in second wall 22 of cavity 2.

As shown in FIG. 13, first port 3, second port 4, and third port 5 are aligned along second axis C2 (in a left-right direction of FIG. 13) of cavity 2, when viewed along first axis C1 of cavity 2.

Straight line L1 passing through first port 3, second port 4, and third port 5 corresponds to a center line in a direction of third axis C3 (in an up-down direction of FIG. 13) of cavity 2, when viewed along first axis C1 of cavity 2. As shown in FIG. 13, when viewed along first axis C1, cavity 2 is line-symmetric with respect to straight line L1 passing through first port 3, second port 4, and third port 5.

As shown in FIG. 13, among first port 3, second port 4, and third port 5, second port 4 is closest to third wall 23 and third port 5 is closest to fourth wall 24. Distance D21 between second port 4 and third wall 23 is set to cause a discharge not to occur between third wall 23 and tip part 41a of antenna 41 in second port 4.

Distance D22 between third port 5 and fourth wall 24 is set to cause a discharge not to occur between fourth wall 24 and tip part 51a of antenna 51 in third port 5. Distance D21 is not equal to distance D22. Distance D21 is larger than distance D22.

As shown in FIG. 13, when viewed along first axis C1, first port 3, second port 4, and third port 5 are aligned along second axis C2 (in a left-right direction of FIG. 13) of cavity 2, and first port 3 is not disposed in the center between second port 4 and third port 5.

In other words, distance D31 between first port 3 and second port 4 is different from distance D32 between first port 3 and third port 5. Distance D31 is smaller than distance D32. Thus, when viewed along first axis C1, second port 4 and third port 5 are not disposed symmetrically with respect to first port 3.

### Second Example

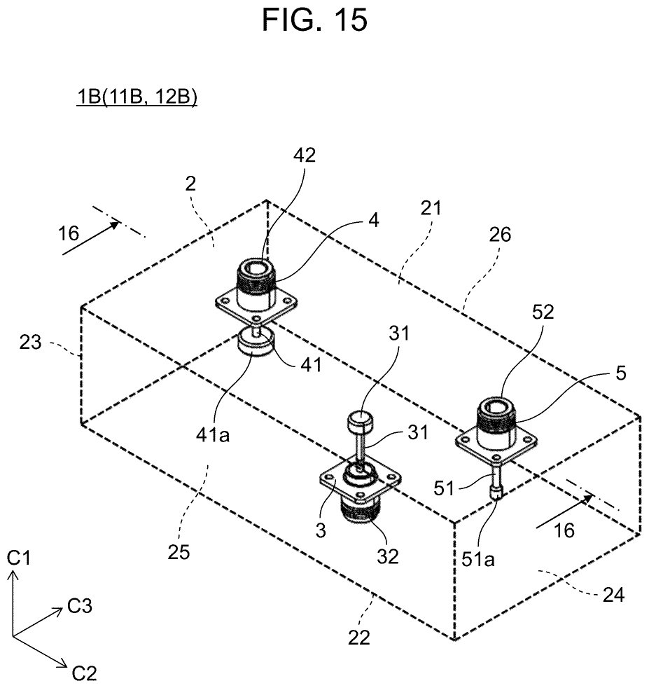

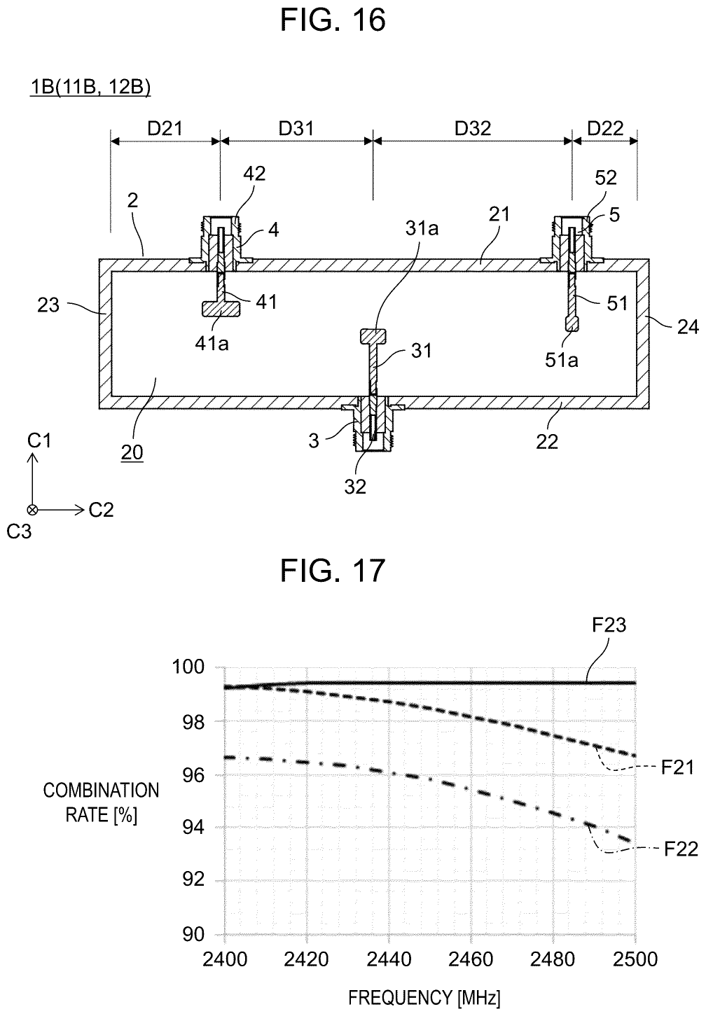

FIGS. 15 and 16 show power distributor/combiner 1B in accordance with a second example of the second exemplary embodiment in the present disclosure. FIG. 15 is a perspective view of power distributor/combiner 1B. FIG. 16 is a cross-sectional view taken along line 16-16 in FIG. 15.

Power distributor/combiner 2B is used as power combiner 11B or power distributor 12B. Power distributor/combiner 1B includes cavity 2, first port 3, second port 4, and third port 5. Power distributor/combiner 1B is different from power distributor/combiner 1A in shapes of first port 3, second port 4, and third port 5, especially in shapes of antennas 31, 41, and 51.

As shown in FIGS. 15 and 16, in power distributor/combiner 1, a shape of antenna 31 in first port 3, a shape of antenna 41 in second port 4, and a shape of antenna 51 in third port 5 are different from one another.

In more detail, tip part 31a of antenna 31, tip part 41a of antenna 41, and tip part 51a of antenna 51 have different diameters from one another. Especially, tip part 41a of antenna 41 has the largest diameter, tip part 31a of antenna 31 has the second largest diameter, and tip part 51a of antenna 51 has the smallest diameter.

Body part 31b of antenna 31, body part 41b of antenna 41, and body part 51b of antenna 51 also have different lengths from one another. Especially, body part 31b of antenna 31 is the longest, body part 51b of antenna 51 is the second longest, and body part 41b of antenna 41 is the shortest.

In the present exemplary embodiment, antennas 31, 41, and 51 are disposed such that each tip part, i.e., tip part 31a, tip part 41a, and tip part 51a are different in position from one another in a direction of first axis C1 of cavity 2.

### EVALUATION

To evaluate power loss in power distributors/combiners 1A and 1B, the inventors have evaluated a combination rate of power distributors/combiners 1A and 1B based on calculation results obtained by using analysis software. To evaluate the combination rate, the inventors have inputted the same high frequency signal to second port 4 and third port 5 and, thereby, evaluated an electric power of the high frequency signal obtained from first port 3.

FIG. 17 is a graph showing an example of a relationship between frequency and a combination rate in power distributors/combiners 1A and 1B. In FIG. 17, a horizontal axis indicates frequency of the high frequency signal inputted to the plurality of input ports (second port 4 and third port 5), and a vertical axis indicates a combination rate. The combination rate is a ratio of the electric power outputted from the output port (first port 3) to the electric power inputted to the plurality of input ports (second port 4 and third port 5).

In FIG. 17, F21 indicates a combination rate of power distributor/combiner 1A, and F22 indicates a combination rate of power distributor/combiner 1B. In FIG. 17, F23 indicates a combination rate of power distributor/combiner 1 in accordance with the first exemplary embodiment.

FIG. 17 clearly shows that, although being decreased as the frequency increases, the combination rate of power distributor/combiner 1A exceeds 98% in frequency ranging from 2400 MHz to 2460 MHz. In other words, power distributor/combiner 1A can reduce power loss with a simple structure.

FIG. 17 clearly shows that, although being decreased as the frequency increases, the combination rate of power distributor/combiner 1B exceeds 96% in frequency ranging from 2400 MHz to 2440 MHz. In other words, power distributor/combiner 1B can reduce power loss with a simple structure.

As shown in FIG. 17, in power distributor/combiner 1A and power distributor/combiner 1B, a change in the combination rate with respect to frequency is large as compared with power distributor/combiner 1 in accordance with the first exemplary embodiment.

This result means that, by changing symmetry in arrangement of first port 3, second port 4, and third port 5 in cavity 2 suitably, a combination rate can be obtained so as to have a desired frequency characteristic. By changing symmetry in shapes of first port 3, second port 4, and third port 5 suitably, the same effect can also be obtained.

### Third Exemplary Embodiment

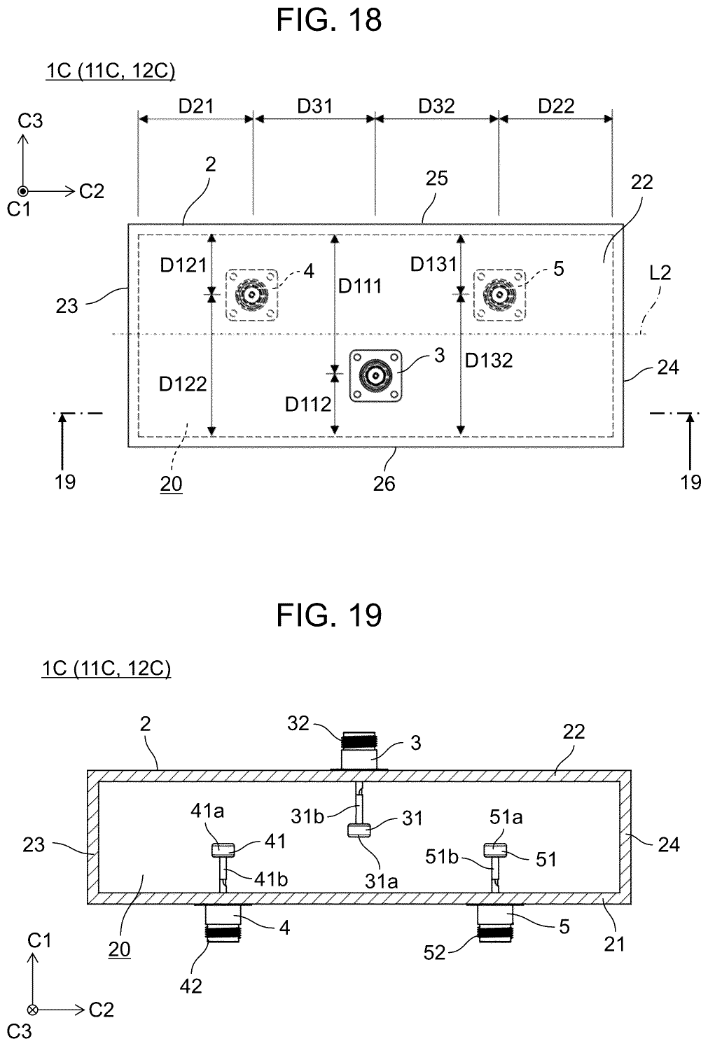

FIGS. 18 and 19 show power distributor/combiner 1C in accordance with a third exemplary embodiment of the present disclosure. FIG. 18 is a plan view of power distributor/combiner 1C. FIG. 19 is a cross-sectional view taken along line 19-19 in FIG. 18.

Power distributor/combiner 1C is used as power combiner 11C or power distributor 12C. Power distributor/combiner 1C includes cavity 2, first port 3, second port 4, and third port 5. Power distributor/combiner 1C is different from power distributor/combiner 1 in accordance with the first exemplary embodiment in a manner of disposing first port 3, second port 4, and third port 5 in cavity 2.

Power distributor/combiner 1C is also different from power distributor/combiner 1 in accordance with the first exemplary embodiment in shapes of first port 3, second port 4, and third port 5, especially in shapes of antennas 31, 41, and 51.

As shown in FIGS. 18 and 19, in power distributor/combiner 1C, second port 4 and third port 5 are disposed in first wall 21 of cavity 2, and first port 3 is disposed in second wall 22 of cavity 2.

As shown in FIG. 18, second port 4 and third port 5 are aligned along second axis C2 (in a left-right direction of FIG. 18) of cavity 2, when viewed along first axis C1 of cavity 2.

First port 3 is not aligned with second port 4 and third port 5 along second axis C2 (in a left-right direction of FIG. 18) of cavity 2, when viewed along first axis C1 of cavity 2. When viewed along first axis C1 of cavity 2, second port 4 and third port 5 are disposed closer to fifth wall 25 than center line L2 in a direction of third axis C3 (in an up-down direction of FIG. 18) of cavity 2 is, and first port 3 is disposed close to sixth wall 26.

Accordingly, distance D111 between first port 3 and fifth wall 25 is different from distance D112 between first port 3 and sixth wall 26. Distance D121 between second port 4 and fifth wall 25 is different from distance D122 between second port 4 and sixth wall 26. Distance D131 between third port 5 and fifth wall 25 is different from distance D132 between third port 5 and sixth wall 26.

In the present exemplary embodiment, distance D111 is larger than distance D112. Distance D121 is smaller than distance D122. Distance D131 is smaller than distance D132. Distances from center line L2 to first port 3, second port 4, and third port 5 are equal to each other.

As shown in FIGS. 18 and 19, second port 4 is closest to third wall 23 and third port 5 is closest to fourth wall 24 among first port 3, second port 4, and third port 5. Distance D21 between second port 4 and third wall 23 is equal to distance D22 between third port 5 and fourth wall 24. Distance D31 between first port 3 and second port 4 is equal to distance D32 between first port 3 and third port 5 in a direction of second axis C2.

A shape of antenna 31 in first port 3 is different from a shape of antenna 41 in second port 4 and a shape of antenna 51 in third port 5.

In more detail, tip part 31a of antenna 31, tip part 41a of antenna 41, and tip part 51a of antenna 51 have the same diameter. However, body part 31b of antenna 31 is longer than body part 41b of antenna 41 and body part 51b of antenna 51.

In the present exemplary embodiment, antennas 31, 41, and 51 are disposed such that each tip part i.e., tip part 31a, tip part 41a, and tip part 51a are different in position from one another in a direction of first axis C1 of cavity 2.

### EVALUATION

To evaluate power loss in power distributor/combiner 1C, the inventors have evaluated a combination rate of power distributor/combiner 1C based on calculation results obtained by using analysis software. To evaluate the combination rate, the inventors have inputted the same high frequency signal to second port 4 and third port 5 and, thereby, evaluated an electric power of the high frequency signal obtained from first port 3.

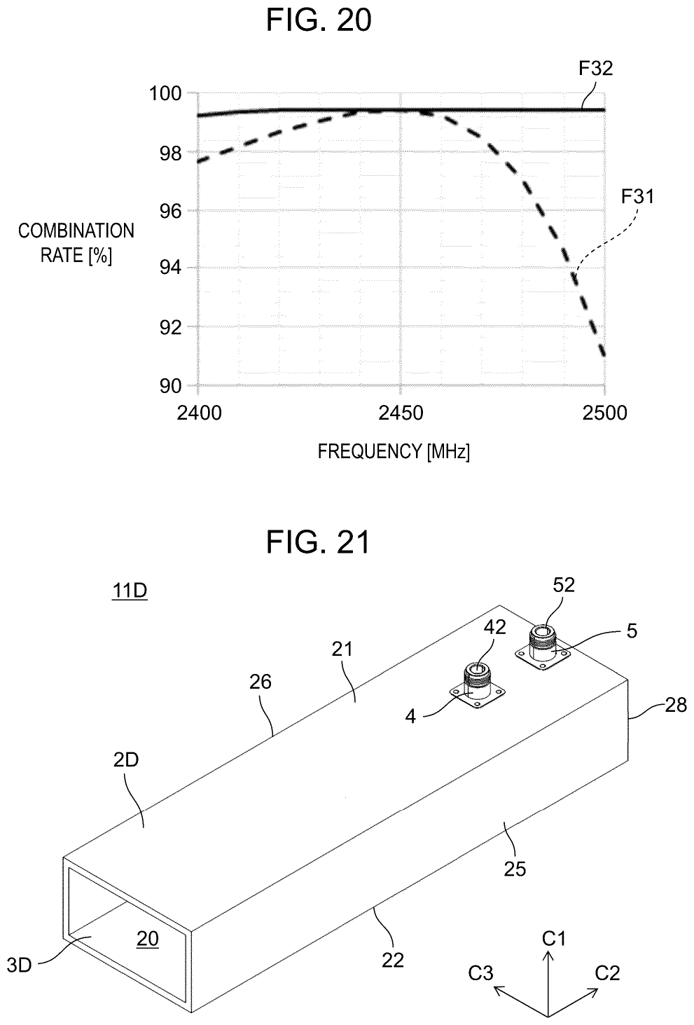

FIG. 20 is a graph showing an example of a relationship between frequency and a combination rate in power distributor/combiner 1C. In FIG. 20, a horizontal axis indicates frequency of the high frequency signal inputted to the plurality of input ports (second port 4 and third port 5), and a vertical axis indicates a combination rate. The combination rate is a ratio of the electric power outputted from the output port (first port 3) to the electric power inputted to the plurality of input ports (second port 4 and third port 5).

In FIG. 20, F31 indicates a combination rate of power distributor/combiner 1C, and F32 indicates the combination rate of power distributor/combiner 1 in accordance with the first exemplary embodiment 1.

FIG. 20 clearly shows that the combination rate of power distributor/combiner 1A is maximized near a frequency of 2450 MHz and, although being decreased as goes away from a frequency of 2450 MHz, exceeds 98% near the maximum value. In other words, power distributor/combiner 1C can reduce power loss with a simple structure.

As shown in FIG. 20, a change in the combination rate of power distributor/combiner 1C with respect to frequency is large as compared with power distributor/combiner 1 in accordance with the first exemplary embodiment.

This result means that, by changing symmetry in arrangement of first port 3, second port 4, and third port 5 in cavity 2 suitably, a combination rate can be obtained so as to have a desired frequency characteristic. By changing symmetry in shapes of first port 3, second port 4, and third port 5 suitably, the same effect can also be obtained.

### Fourth Exemplary Embodiment

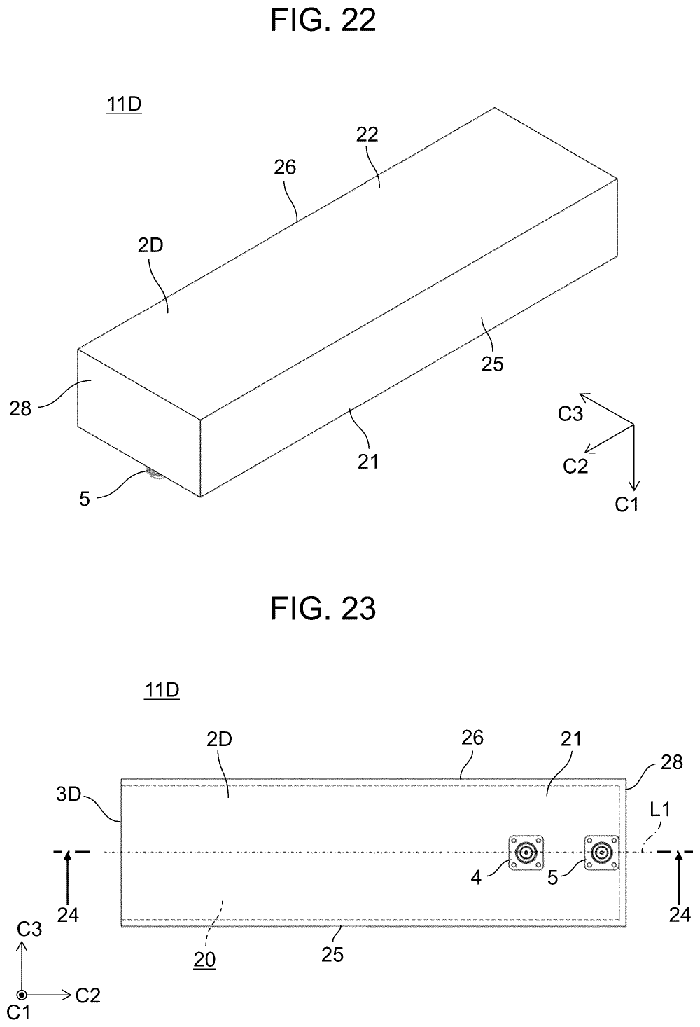

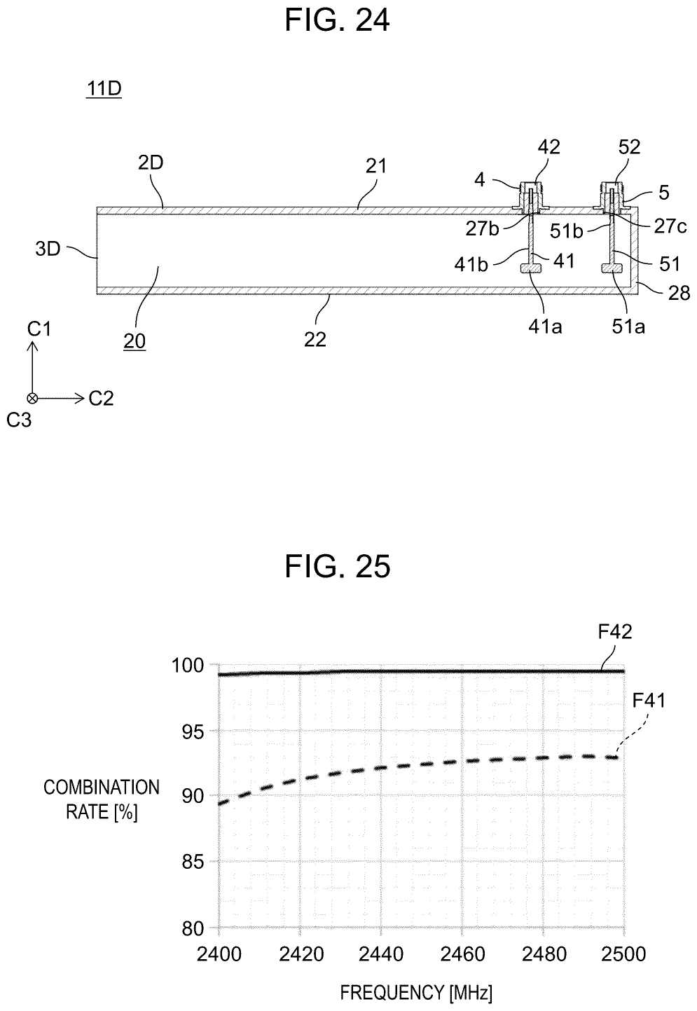

FIGS. 21 through 24 show power combiner 11D in accordance with a fourth exemplary embodiment of the present disclosure. FIG. 21 is a perspective view showing power combiner 11D when viewed from the above. FIG. 22 is a perspective view showing power combiner 11D when viewed from the below. FIG. 23 is a plan view of power combiner 11D. FIG. 24 is a cross-sectional view taken along line 24-24 in FIG. 23.

As shown in FIGS. 21 through 24, power combiner 11D includes cavity 2D, first port 3D, second port 4, and third port 5.

Cavity 2D has internal space 20 sealed electromagnetically. Cavity 2D is made of metal. Cavity 2D has a rectangular parallelepiped shape. Cavity 2D has first wall 21 and second wall 22 that intersect with first axis C1 perpendicularly. First wall 21 and second wall 22 each have a rectangular plate of the same shape.

Cavity 2D has a first end that is opened in a direction of second axis C2, and a second end that is bottomed. An opening is formed at the first end of cavity 2D in the direction of second axis C2 to constitute first port 3D. Second axis C2 is a direction that intersects with first axis C1 perpendicularly, and first axis C1 and second axis C2 indicate an up-down direction and a left-right direction in FIG. 24, respectively.

Cavity 2D has side wall 28 disposed at the second end in the direction of second axis C2. Side wall 28 has a rectangular plate. Cavity 2D has fifth wall 25 and sixth wall 26 that intersect with third axis C3 perpendicularly. Third axis C3 is a direction that intersects with both of first axis C1 and second axis C2 perpendicularly, and indicates an up-down direction in FIG. 23.

Fifth wall 25 and sixth wall 26 each have a rectangular plate of the same shape. In the present exemplary embodiment, cavity 2D has the largest dimension along second axis C2, the second largest dimension along third axis C3, and the smallest dimension along first axis C1.

Furthermore, cavity 2D has mounting hole 27b and mounting hole 27c into which second port 4 and third port 5 are attached, respectively. Internal space 20 of cavity 2 is surrounded by first wall 21, second wall 22, fifth wall 25, sixth wall 26, and side wall 28 to be sealed electromagnetically. Mounting hole 27b and mounting hole 27c are disposed so as to be positionally aligned with second port 4 and third port 5 in cavity 2D, respectively.

As shown in FIGS. 21, 23, and 24, first port 3D is an opening formed in cavity 2D. First port 3D is disposed at a first end (left end in FIGS. 23 and 24) of cavity 2D in a direction of second axis C2. Second axis C2 intersects with first axis C1 perpendicularly. First port 3D is an opening formed over the first end of cavity 2D.

As shown in FIG. 24, antenna 41 and connector 42 are disposed in second port 4. Antenna 51 and connector 52 are disposed in third port 5. In other words, first port 3D has no antenna and no connector, unlike second port 4 and third port 5.

In the present exemplary embodiment, as shown in FIG. 24, a shape of antenna 41 in second port 4 is the same as a shape of antenna 51 in third port 5. In more detail, tip parts 41a and 51a of antennas 41 and 51 have the same diameter and length, and body parts 41b and 51b of antennas 41 and 51 have the same diameter and length.

In the present exemplary embodiment, as shown in FIG. 21, second port 4 and third port 5 are disposed in first wall 21 of cavity 2D. Furthermore, second port 4 and third port 5 are disposed on a second end side (side wall 28 side) of cavity 2D in a direction of second axis C2.

In the present exemplary embodiment, as shown in FIG. 23, second port 4 and third port 5 are aligned along second axis C2 (in a left-right direction of FIG. 23) of cavity 2, when viewed along first axis C1 of cavity 2. Straight line L1 passing through second port 4 and third port 5 corresponds to a center line in a direction of third axis C3 (in an up-down direction of FIG. 23) of cavity 2, when viewed along first axis C1 of cavity 2. In FIG. 23, when viewed along first axis C1, cavity 2 is line-symmetric with respect to straight line L1 passing through second port 4 and third port 5.

In power combiner 11D, first port 3D is used as an output port, and second port 4 and third port 5 are used as a plurality of input ports. Power combiner 11D combines electric powers inputted to second port 4 and third port 5, and outputs the combined electric power from first port 3D.

### EVALUATION

To evaluate power loss in power combiner 11D, the inventors have evaluated a combination rate of power combiner 11D based on calculation results obtained by using analysis software. To evaluate the combination rate, the inventors have inputted the same high frequency signal to second port 4 and third port 5 and, thereby, evaluated an electric power of the high frequency signal obtained from first port 3D.

FIG. 25 is a graph showing an example of a relationship between frequency and a combination rate in power combiner 11D. In FIG. 25, a horizontal axis indicates frequency of the high frequency signal inputted to the plurality of input ports (second port 4 and third port 5), and a vertical axis indicates a combination rate. The combination rate is a ratio of the electric power outputted from the output port (first port 3D) to the electric power inputted to the plurality of input ports (second port 4 and third port 5).

In FIG. 25, F41 indicates a combination rate of power combiner 11D, and F42 indicates the combination rate of power distributor/combiner 1 in accordance with the first exemplary embodiment.

FIG. 25 clearly shows that the combination rate of power distributor/combiner 1A is increased as the frequency increases, and exceeds 90% in frequency ranging from 2410 MHz to 2500 MHz. In other words, power combiner 11D can reduce power loss with a simple structure.

Note that, in FIG. 25, the combination rate falls below 90% at a frequency of 2400 MHz. It is considered that this occurs due to a fact that a radio wave emitted from antenna 41 of the second port 4 and a radio wave emitted from antenna 51 of third port 5 cannot be matched to each other in phase, because second port 4 is disposed between first port 3D and third port 5.

### MODIFICATION

The present disclosure is not limited to the above-mentioned exemplary embodiments. Hereinafter, modifications of the above-mentioned exemplary embodiments will be described. Each of the following modifications can also be suitably combined with the above-mentioned exemplary embodiment and the other modification.

In one of modifications, a shape of cavity 2 is not limited in particular. For the first exemplary embodiment, a dimension of element along each of first axis C1, second axis C2, and third axis C3 of cavity 2 may be determined suitably in consideration of arrangement of the input port and the output port, frequency of the high frequency signal inputted to the input port, or the like.

The dimension of element along each of first axis C1, second axis C2, and third axis C3 of cavity 2 depends on efficiency (power loss) and a frequency characteristic. To optimize one dimension, the other dimensions are fixed. Thus, when dimensions of cavity 2 are determined, a dimension to be fixed and a dimension to be optimized may be changed hierarchically.

For instance, to determine dimensions of cavity 2 along first axis C1, second axis C2, and third axis C3, optimization of the dimensions is performed as follows: first, the dimension along first axis C1 and the dimension along second axis C2 are fixed to optional numerical values to optimize the dimension along third axis C3. Next, without changing the dimension along first axis C1, the dimension along second axis C2 is changed to optimize the dimension along third axis C3.

Thus, an optimal combination of the dimension along second axis C2 and the dimension along third axis C3 is searched with respect to the current dimension along first axis C1. The dimension along first axis C1 is changed to search the optimal combination of the dimension along second axis C2 and the dimension along third axis C3. Thus, an optimal combination of the dimension along first axis C1, the dimension along second axis C2, and the dimension along third axis C3 is searched.

Note that, in the case where the power combiner and the power distributor have the same structure like the first exemplary embodiment through the third exemplary embodiment, if an S parameter (Scattering parameter) for the power distributor is obtained, optimization can be performed using a Smith chart.

In one of modifications, a shape of cavity 2 is not limited to a rectangular parallelepiped. Cavity 2 may have a circular shape or a polygonal box-like shape. As mentioned above, each dimension of cavity 2 may be set suitably in consideration of arrangement of the input port and the output port, frequency of the high frequency signal inputted to the input port, or the like.

In one of modifications, the number of input ports in the power combiner is not limited. The number of input ports is not limited to two. The number may be three or more. The number of output ports in the power distributor is not limited. The number of output ports is not limited to two. The number may be three or more.

In one of modifications, an output port of the power distributor may be an opening formed in cavity 2. For instance, an input port may be disposed in first wall 21 of cavity 2, and an opening, which functions as the output port, may be formed in each of third wall 23 and fourth wall 24 of cavity 2.

In one of modifications, antenna 31 in first port 3, antenna 41 in second port 4, and antenna 51 in third port 5 are not limited in shape. Connector 32 in first port 3, connector 42 in second port 4, and connector 52 in third port 5 are not limited in shape.

Positions of first port 3, second port 4, and third port 5 are not limited to the ones shown in the above-mentioned exemplary embodiments, either. For instance, first port 3, second port 4, and third port 5 all may be disposed in one wall (e.g., first wall 21 or second wall 22). Second port 4 and third port 5 may be disposed in different walls (e.g., first wall 21 and second wall 22, respectively) other than the one wall.

### ASPECT AND EFFECT

As mentioned above, the present disclosure includes the following aspects, as described in detail. In the following aspects, to clarify correspondence between the above-mentioned exemplary embodiments, a reference numeral with parentheses is added thereto.

Power combiner (11; 11A; 11B; 11C; 11D) of a first aspect of the present disclosure includes cavity (2;2D), a plurality of input ports (4, 5), a plurality of input antennas (41, 51), and output port (3;3D).

Cavity (2;2D) includes internal space (20) sealed electromagnetically. The plurality of input ports (4, 5) are disposed in cavity (2;2D). Each of the plurality of input antennas (41, 51) is disposed in a corresponding input port among the plurality of input ports (4, 5), and disposed inside internal space (20). Output port (3;3D) is disposed in cavity (2;2D). This aspect can reduce power loss with a simple structure.

In power combiner (11; 11A; 11B; 11C; 11D) of a second aspect of the present disclosure, in addition to the first aspect, the plurality of input antennas (41, 51) are configured to emit input radio waves, which correspond to the electric powers inputted to the plurality of input ports (4, 5), to internal space (20). Output port (3) is configured to output a combined wave of the input radio waves to the outside of internal space (20). This aspect can reduce power loss with a simple structure.

In addition to the second aspect, power combiner (11; 11A; 11B; 11C, 11D) of a third aspect of the present disclosure further includes output antenna (31) that is connected to output port (3) and disposed inside internal space (20). This aspect can reduce power loss with a simple structure.

In power combiner (11; 11A; 11B; 11C) of a fourth aspect of the present disclosure, in addition to the third aspect, output antenna (31) is disposed at an antinode position of a standing wave that is caused by the input radio waves emitted from the plurality of input antennas (41, 51), when output port (3) is not provided. This aspect can further reduce power loss.

In power combiner (11; 11A; 11B; 11C) of a fifth aspect of the present disclosure, in addition to the third aspect or the fourth aspect, output antenna (31) is disposed to cause a discharge not to occur between tip part (31a) of output antenna (31) and cavity (2). This aspect can reduce an influence of discharge occurring between output antenna (31) and cavity (2).

In power combiner (11; 11A; 11C) of a sixth aspect of the present disclosure, in addition to any of the third aspect to the fifth aspect, the plurality of input antennas (41, 51) have the same shape as output antenna (31). This aspect can further reduce power loss.

In power combiner (11; 11A; 11C; 11D) of a seventh aspect of the present disclosure, in addition to any of the first aspect to the fifth aspect, each of the plurality of input antennas (41, 51) has the same shape. This aspect can further reduce power loss.

In power combiner (11; 11A; 11B; 11C; 11D) of an eighth aspect of the present disclosure, in addition to any of the first aspect to the seventh aspect, the plurality of input antennas (41, 51) are disposed to cause a discharge not to occur between each tip part (41a, 51a) of the plurality of input antennas (41, 51) and cavity (2;2D). This aspect can reduce an influence of discharge occurring between the plurality of input antennas (41, 51) and cavity (2;2D).

In power combiner (11; 11A; 11B) of a ninth aspect of the present disclosure, in addition to any of the first aspect to the eighth aspect, cavity (2;2D) includes first wall (21) and second wall (22) that intersect with first axis C1 perpendicularly. The plurality of input ports (4, 5) are disposed in first wall (21).

The plurality of input ports (4, 5) and output port (3) are aligned along second axis C2 that intersects with first axis C1 perpendicularly. When viewed along first axis C1, cavity (2) is line-symmetric with respect to straight line (L1) passing through the plurality of input ports (4, 5) and output port (3). This aspect can further reduce power loss.

In power combiner (11; 11A; 111B) of a tenth aspect of the present disclosure, in addition to the ninth aspect, the plurality of input ports (4, 5) are disposed symmetrically with respect to output port (3), when viewed along first axis C1. This aspect can further reduce power loss.

In power combiner (11) of an eleventh aspect of the present disclosure, in addition to the ninth aspect or the tenth aspect, cavity (2) includes third wall (23) and fourth wall (24) that intersect with second axis C2 perpendicularly.

Distance (D21) between input port (4), which is located closest to third wall (23) among the plurality of input ports (4, 5), and third wall (23) is equal to distance (D22) between input port (5), which is located closest to fourth wall (24) among the plurality of input ports (4, 5), and fourth wall (24). This aspect can further reduce power loss.

In power combiner (11; 11A; 111B) of a twelfth aspect of the present disclosure, output port (3) is disposed in second wall (22) in any of the ninth aspect to the eleventh aspect. This aspect can reduce power loss with a simple structure.

In power combiner (1D) of a thirteenth aspect of the present disclosure, in addition to the first aspect, output port (3D) is an opening formed in cavity (2D). This aspect can reduce power loss with a simple structure.

In power combiner (1D) of a fourteenth aspect of the present disclosure, in addition to the thirteenth aspect, cavity (2D) includes first wall (21) and second wall (22) that intersect with first axis C1 perpendicularly. Each of the plurality of input ports (4, 5) is disposed in first wall (21) or second wall (22).

Output port (3D) is disposed at a first end of cavity (2D) in a direction of second axis C2 that intersects with first axis C1 perpendicularly. The plurality of input ports (4, 5) are disposed closer to a second end side than the center of cavity (2D) in a direction of second axis C2. This aspect can reduce power loss with a simple structure.

In power combiner (1D) of a fifteenth aspect of the present disclosure, in addition to the fourteenth aspect, the plurality of input ports (4, 5) are aligned along second axis C2. When viewed along first axis C1, cavity (2D) is line-symmetric with respect to a straight line passing through the plurality of input ports (4, 5). This aspect can further reduce power loss.

Power distributor (12; 12A; 12B; 12C) of a sixteenth aspect of the present disclosure includes cavity (2), input port (3), input antenna (31), and a plurality of output ports (4, 5).

Cavity (2) includes internal space (20) sealed electromagnetically. Input port (3) is disposed in cavity (2). Input antenna (31) is connected to input port (3), and disposed inside internal space (20). The plurality of output ports (4, 5) are disposed in cavity (2). This aspect can reduce power loss with a simple structure.

In power distributor (12; 12A; 12B; 12C) of a seventeenth aspect of the present disclosure, in addition to the sixteenth aspect, input antenna (31) is configured to emit an input radio wave, which corresponds to the electric power inputted to input port (3), to internal space (20). The plurality of output ports (4, 5) are configured to distribute the input radio wave and to output it to the outside of internal space (20). This aspect can reduce power loss with a simple structure.

In addition to the sixteenth aspect, power distributor (12; 12A; 12B; 12C) of an eighteenth aspect of the present disclosure further includes a plurality of output antennas (41, 51) each being disposed in a corresponding output port among the plurality of output ports (4, 5). The plurality of output antennas (41, 51) are disposed inside internal space (20). This aspect can reduce power loss with a simple structure.

In power distributor (12; 12A; 12B; 12C) of a nineteenth aspect of the present disclosure, in addition to the eighteenth aspect, each of the plurality of output antennas (41, 51) is disposed at an antinode position of a standing wave that is caused by the input radio wave emitted from input antenna (31), when the plurality of output ports (4, 5) are not provided. This aspect can further reduce power loss.

In power distributor (12; 12A; 12B; 12C) of a twentieth aspect of the present disclosure, in addition to the eighteenth aspect or the nineteenth aspect, the plurality of output antennas (41, 51) are disposed to cause a discharge not to occur between each tip part (41a, 51a) of the plurality of output antennas (41, 51) and cavity (2). This aspect can reduce an influence of discharge occurring between output antenna (41, 51) and cavity (2).

In power distributor (12; 12A; 12C) of a twenty-first aspect of the present disclosure, in addition to any of the eighteenth aspect to the twentieth aspect, each of the plurality of output antennas (41, 51) has the same shape. This aspect can further reduce power loss. This aspect can distribute the electric power to the plurality of output ports (4, 5) more evenly.

In power distributor (12; 12A; 12C) of a twenty-second aspect of the present disclosure, in addition to any of the eighteenth aspect to the twenty-first aspect, input antenna (31) has the same shape as each of the plurality of output antennas (41, 51). This aspect can further reduce power loss. This aspect can distribute the electric power to the plurality of output ports (4, 5) more evenly.

In power distributor (12; 12A; 12B; 12C) of a twenty-third aspect of the present disclosure, in addition to the twenty-first aspect, input antenna (31) is disposed to cause a discharge not to occur between tip part (31a) of input antenna (31) and cavity (2). This aspect can reduce an influence of discharge occurring between input antenna (31) and cavity (2).

In power distributor (12; 12A; 12B) of the twenty-fourth aspect of present disclosure, in addition to any of the sixteenth aspect to the twenty-third aspect, cavity (2) has first wall (21) and second wall (22) that intersect with first axis C1 perpendicularly. The plurality of output ports (4, 5) are disposed in first wall (21).

The plurality of output ports (4, 5) and input port (4) are aligned along second axis C2 that intersects with first axis C1 perpendicularly. When viewed along first axis C1, cavity (2) is line-symmetric with respect to straight line (L1) passing through the plurality of output ports (4, 5) and input port (3). This aspect can further reduce power loss. This aspect can distribute the electric power to the plurality of output ports (4, 5) more evenly.

In power distributor (12) of a twenty-fifth aspect of the present disclosure, in addition to the twenty-fourth aspect, the plurality of output ports (4, 5) are disposed symmetrically with respect to input port (3), when viewed along first C1. This aspect can further reduce power loss. This aspect can distribute the electric power to the plurality of output ports (4, 5) more evenly.

In power distributor (12; 12A; 12B; 12C) of a twenty-sixth aspect of the present disclosure, in addition to the twenty-fourth aspect or the twenty-fifth aspect, cavity (2) has third wall (23) and fourth wall (24) that intersect with second axis C2 perpendicularly.

Distance (D21) between output port (4), which is located closest to third wall (23) among the plurality of output ports (4, 5), and third wall (23) is equal to distance (D22) between output port (5), which is located closest to fourth wall (24) among the plurality of output ports (4, 5), and fourth wall (24). This aspect can further reduce power loss. This aspect can distribute the electric power to the plurality of output ports (4, 5) more evenly.

In power distributor (12; 12A; 12B; 12C) of a twenty-seventh aspect of the present disclosure, in addition to any of the twenty-fourth aspect to the twenty-sixth aspect, input port (3) is disposed in second wall (22). This aspect can reduce power loss with a simple structure.

### INDUSTRIAL APPLICABILITY

The present disclosure is applicable to, especially, a power combiner and a power distributor for high frequency signals.

### REFERENCE MARKS IN THE DRAWINGS

| 1, 1A, 1B, and 1C | power distributor/combiner |
|---|---|
| 11, 11A, 11B, 11C, and 11D | power combiner |
| 12, 12A, 12B, and 12C | power distributor |
| 2 2D | cavity |
| 20 | internal space |
| 21 | first wall |
| 22 | second wall |
| 23 | third wall |
| 24 | fourth wall |
| 25 and 26 | wall |
| 27a, 27b, and 27c | mounting hole |
| 28 | side wall |
| 3 3D | first port |
| 31 | antenna |
| 31a, 41a, and 51a | tip part |
| 31b, 41b, and 51b | body part |
| 32, 42, and 52 | connector |
| 32a, 42a, and 52a | inner conductor |
| 32b, 42b, and 52b | outer conductor |
| 32c, 42c, and 52c | insulator |
| 4 | second port |
| 41 | antenna |
| 5 | third port |
| 51 | antenna |

1. A power combiner comprising:
a cavity including an internal space sealed electromagnetically;
a plurality of input ports that are disposed in the cavity;
a plurality of input antennas that are disposed inside the internal space, the plurality of input antennas each being disposed in a corresponding input port among the plurality input ports; and
an output port that is disposed in the cavity.

2. The power combiner according to claim 1, wherein:
the plurality of input antennas are configured to emit input radio waves to the internal space, the input radio waves corresponding to electric powers inputted to the plurality of input ports; and
the output port is configured to output a combined wave of the input radio waves to an outside of the internal space.

3. The power combiner according to claim 1, further comprising an output antenna that is disposed in the output port and disposed inside the internal space.

4. The power combiner according to claim 3, wherein
when the output port is not provided, the output antenna is disposed at an antinode position of a standing wave that is caused by the input radio waves emitted from the plurality of input antennas.

5. The power combiner according to claim 3, wherein
the output antenna is disposed to cause a discharge not to occur between a tip part of the output antenna and the cavity.

6. The power combiner according to claim 3, wherein
each of the plurality of input antennas has an identical shape to the output antenna.

7. The power combiner according to claim 1, wherein
each of the plurality of input antennas has an identical shape.

8. The power combiner according to claim 1, wherein
the plurality of input antennas are disposed to cause a discharge not to occur between each tip part of the plurality of input antennas and the cavity.

9. The power combiner according to claim 1, wherein
the cavity includes a first wall and a second wall that intersect with a first axis perpendicularly,
the plurality of input ports are disposed in the first wall,
the plurality of input ports and the output port are aligned along a second axis that intersects with the first axis perpendicularly, and
the cavity is line-symmetric with respect to a straight line passing through the plurality of input ports and the output port, when viewed along the first axis.

10. The power combiner according to claim 9, wherein
the plurality of input ports are disposed symmetrically with respect to the output port, when viewed along the first axis.

11. The power combiner according to claim 9, wherein
the cavity includes a third wall and a fourth wall that intersect with the second axis perpendicularly, and
a distance between the third wall and an input port located closest to the third wall among the plurality of input ports is equal to a distance between the fourth wall and an input port located closest to the fourth wall among the plurality of input ports.

12. The power combiner according to claim 9, wherein
the output port is disposed in the second wall.

13. The power combiner according to claim 1, wherein
the output port is an opening that is formed in the cavity.

14. The power combiner according to claim 13, wherein
the cavity includes a first wall and a second wall that intersect with a first axis perpendicularly,
each of the plurality of input ports is disposed in the first wall or the second wall,
the output port is disposed at a first end of the cavity in a direction of a second axis that intersects with the first axis perpendicularly, and
the plurality of input ports are disposed closer to a second end side than a center of the cavity in a direction of the second axis.

15. The power combiner according to claim 14, wherein
the plurality of input ports are aligned along the second axis, and
the cavity is line-symmetric with respect to a straight line passing through the plurality of input ports, when viewed along the first axis.

16. A power distributor comprising:
a cavity including an internal space sealed electromagnetically;
an input port that is disposed in the cavity;
an input antenna that is disposed in the input port and disposed inside the internal space; and
a plurality of output ports that are disposed in the cavity.

17. The power distributor according to claim 16, wherein
the input antenna is configured to emit an input radio wave to the internal space, the input radio wave corresponding to an electric power inputted to the input port; and
the plurality of output ports are configured to distribute the input radio wave and to output distributed radio waves to an outside of the internal space.

18. The power distributor according to claim 16, further comprising
a plurality of output antennas that are disposed inside the internal space, the plurality of output antennas each being disposed in a corresponding output port among the plurality of output ports.

19. The power distributor according to claim 18, wherein
when the plurality of output ports are not provided, each of the plurality of output antennas is disposed at an antinode position of a standing wave that is caused by the input radio wave emitted from the input antenna.

20. The power distributor according to claim 18, wherein
the plurality of output antennas are disposed to cause a discharge not to occur between each tip part of the plurality of output antennas and the cavity.

21. The power distributor according to claim 18, wherein
each of the plurality of output antennas has an identical shape.

22. The power distributor according to claim 18, wherein
the input antenna has an identical shape to each of the plurality of output antennas.

23. The power distributor according to claim 16, wherein
the input antenna is disposed to cause a discharge not to occur between a tip part of the input antenna and the cavity.

24. The power distributor according to claim 16, wherein
the cavity has a first wall and a second wall that intersect with a first axis perpendicularly,
the plurality of output ports are disposed in the first wall,
the plurality of output ports and the input port are aligned along a second axis that intersects with the first axis perpendicularly, and
the cavity is line-symmetric with respect to a straight line passing through the plurality of output ports and the input port, when viewed along the first axis.

25. The power distributor according to claim 24, wherein
the plurality of output ports are disposed symmetrically with respect to the input port, when viewed along the first axis.

26. The power distributor according to claim 24, wherein
the cavity has a third wall and a fourth wall that intersect with the second axis perpendicularly, and
a distance between the third wall and an output port located closest to the third wall among the plurality of output ports is equal to a distance between the fourth wall and an output port located closest to the fourth wall among the plurality of output ports.

27. The power distributor according to claim 24, wherein
the input port is disposed in the second wall.
